(19) United States
(12) Patent Application Publication
(10) Pub. No.: US 2005/0211704 A1
(43) Pub. Date: Sep. 29, 2005

(54) System and methods for providing fresh potatoes

(76) Inventor: Dennis West, Rice Lake, WI (US)

Correspondence Address: Jonathan Spangler, Unit 306, 1780 Kettner Blvd., San Diego, CA, 92101, US

(21) Appl. No.: 10/807,611

(22) Filed: Mar. 24, 2004

(51) Int. Cl. H05B 6/80

(52) U.S. Cl. 219/734

(57) ABSTRACT

A system and related methods for providing fresh potatoes for consumption, involving providing one or more potatoes within a container of suitable construction to be placed in and withstand an environment capable of cooking fresh potatoes.

### BACKGROUND OF THE INVENTION

I. Field of the Invention

The present invention relates generally to fresh potatoes, and more particularly to a system and related methods for providing fresh potatoes for consumption.

II. Discussion of the Prior Art

Fresh potatoes are typically packaged and presented to consumers in traditional plastic bags or cardboard boxes oftentimes containing a large quantity of potatoes. Prior to packaging in such traditional plastic bags or cardboard boxes, the potatoes may or may not be washed. Based on the large quantity of the potatoes typically packaged within these prior art plastic bags or cardboard boxes, a consumer will normally only use a portion of the potatoes for a given meal. As such, one or more potatoes are removed from the plastic bag or cardboard box, washed to ensure cleanliness, placed within or on articles for cooking, and thereafter cooked via any number of methods, such as baking in a convection oven, cooking in a microwave oven, and boiling on a stovetop and/or in a microwave oven. The articles for cooking may include a pan and/or wrapped in foil in the case of baking in a convection oven, a plate or other container for cooking in a microwave oven, or a pot of water in the case of stovetop cooking. After the potatoes are cooked, any of a variety of condiments may be employed to augment the taste of the potatoes for final consumption (such as butter, margarine and/or any of a variety of dressings).

Although generally effective, this prior art manner of preparing fresh potatoes nonetheless suffers various drawbacks. One drawback is the overall inefficiency involved in the multiple steps required in this prior art preparation process, which adds to the overall preparation time and creates unnecessary inconvenience. Another drawback involves the requirement of placing the potatoes within or on articles for cooking, in that this requires time prior to cooking (to retrieve the pan, foil, plate or pot from storage and place the potatoes thereon or therein), and also creates post-cooking inconvenience based on the need to wash and store the pan, plate or pots. Another drawback is that the condiments (such as butter, margarine and/or dressings) involved in preparing the potatoes for final consumption do not come with the potatoes. This creates yet another level of inconvenience, in that these condiments must be purchased separately and, based on the fact they can be used other food, are likely to be consumed at a different rate than the potatoes, thereby raising the possibility of having an insufficient quantity of condiments when the potatoes are cooked and ready to be prepared for final consumption.

The present invention is directed at overcoming, or at least reducing the effects of, one or more of the problems set forth above.

### SUMMARY OF THE INVENTION

According to a broad aspect of the present invention, the above-identified drawbacks of the prior art are overcome by providing a system for providing fresh potatoes for consumption, comprising a container of suitable construction to be placed in and withstand an environment capable of cooking fresh potatoes, and one or more fresh potatoes placed within said container.

According to another broad aspect, the above-identified drawbacks of the prior art are overcome by providing a method of providing fresh potatoes for consumption, comprising the steps of: (a) packaging one or more fresh potatoes within a container of suitable construction to be placed in and withstand an environment capable of cooking fresh potatoes; and (b) distributing the container to a consumer.

### BRIEF DESCRIPTION OF THE DRAWINGS

Other objects and advantages of the invention will become apparent upon reading the following detailed description and upon reference to the drawings in which:

FIG. 1 is a perspective view of a system for providing fresh potatoes according to an illustrative embodiment of the present invention, including a microwaveable container with a plurality of fresh potatoes disposed therein;

FIG. 2 is a perspective view of a system for providing fresh potatoes according to another illustrative embodiment of the present invention, including a condiment packet disposed with the fresh potatoes in the microwaveable container;

FIG. 3 is a side view (in exploded form) of the system for providing fresh potatoes shown in FIG. 2, including a packaging cover with, among other things, instructions for preparing the fresh potatoes within the microwaveable container;

FIG. 4 is a top view of the packaging cover shown in FIG. 3, illustrating the various types of information to communicate (e.g. Preparation Instructions, Nutrition Facts, Brand Name, Graphics, Bar Code) as well as the construction of the packaging cover; and

FIGS. 5-6 are illustrative examples of different embodiments of the Graphics for the packaging cover shown in FIG. 4.

### DESCRIPTION OF THE PREFERRED EMBODIMENT

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

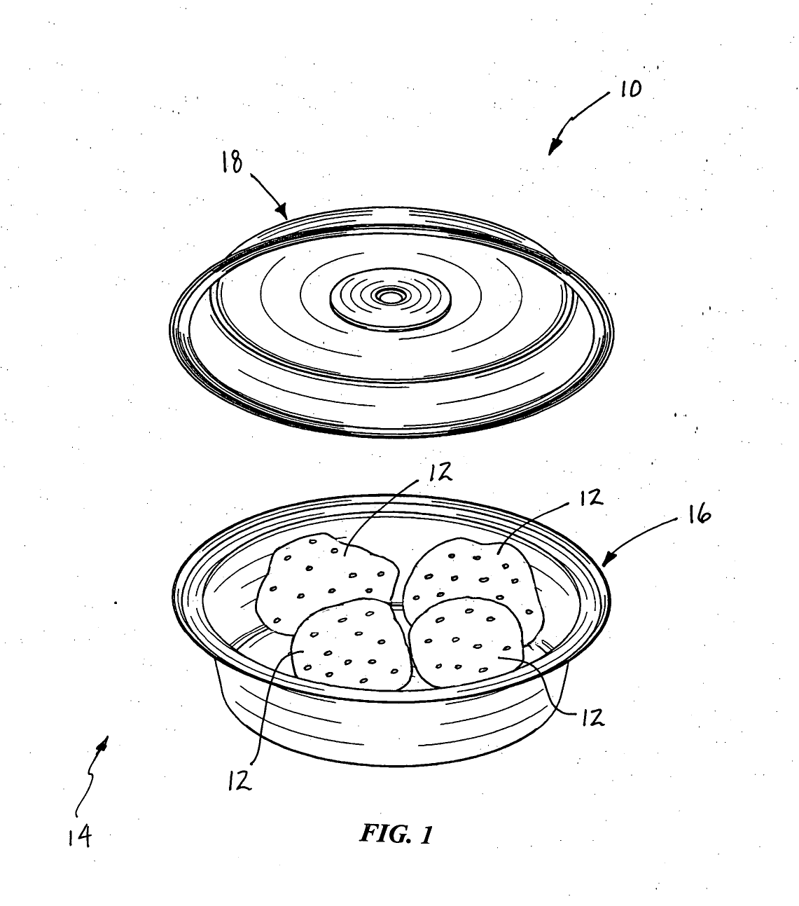

FIG. 1 illustrates a system 10 for providing fresh potatoes according to an exemplary embodiment of the present invention. The system 10 includes one or more fresh potatoes 12 disposed within a container 14 of suitable construction to be placed in and withstand an environment capable of cooking fresh potatoes. The system 10 is ideally available to consumers through any number of suitable commercial outlets, such as a grocery store, with the fresh potatoes 12 pre-packaged and sealed within the container 14. When the consumer wishes to cook the fresh potatoes 12 for consumption, he or she may simply remove the system 10 from storage (e.g. refrigerator, pantry, etc . . . ), place it within a cooking environment for a sufficient duration to cook the fresh potatoes 12, and thereafter remove the container 14 from the cooking environment with the fresh potatoes 12 cooked and ready for consumption or further preparation. As will be described below, there may be optional additional steps involved in this overall process (e.g. removing any outer packaging and/or condiment packet from the container 14 (if present), venting the container 14 (if desired), and emptying a condiment packet onto the fresh potatoes 12 after cooking (if desired)); however, the above-identified steps comprise a fundamental aspect of the present invention.

The number of fresh potatoes 12 disposed within the container 14 may vary depending upon the situation, such as the number of people eating the fresh potatoes and the anticipated consumption per person. By way of example only, there are four fresh potatoes 12 shown which may be suitable for two to three people. Although not shown, it is to be readily understood that the number of fresh potatoes 12 may range from one (for a single serving) to a plurality (such as 6-8 or more for a family serving). According to the present invention, the fresh potatoes 12 are washed one or more times prior to being packaged within the container 14, which advantageously eliminates the need for the consumer to undertake any further washing steps during the use of system 10.

In a preferred embodiment, the container 14 comprises a tray 16 with a cover 18, both of which are constructed so as to withstand the process of cooking the fresh potatoes 12 for a suitable duration within a microwave oven. By way of example only, the container 14 may be of the types shown and described in U.S. Pat. No. 6,056,138, U.S. Pat. No. 5,833,116 and U.S. Design Pat. No. D415,420, the entire contents of which are hereby incorporated by reference as if set forth fully herein. Although shown and described herein as microwaveable and of two-piece construction, it will be appreciated that the container 14 may take the form of any number of suitable shapes and dimensions (e.g. spherical, square, rectangular, triangular, oblong, etc . . . ), may be of unitary of multi-piece construction, and may be constructed from any number of materials (e.g. plastics, composites, metal, etc . . . ) which would allow it to withstand any number of different cooking environments (e.g. convection oven, within boiling water, etc . . . ).

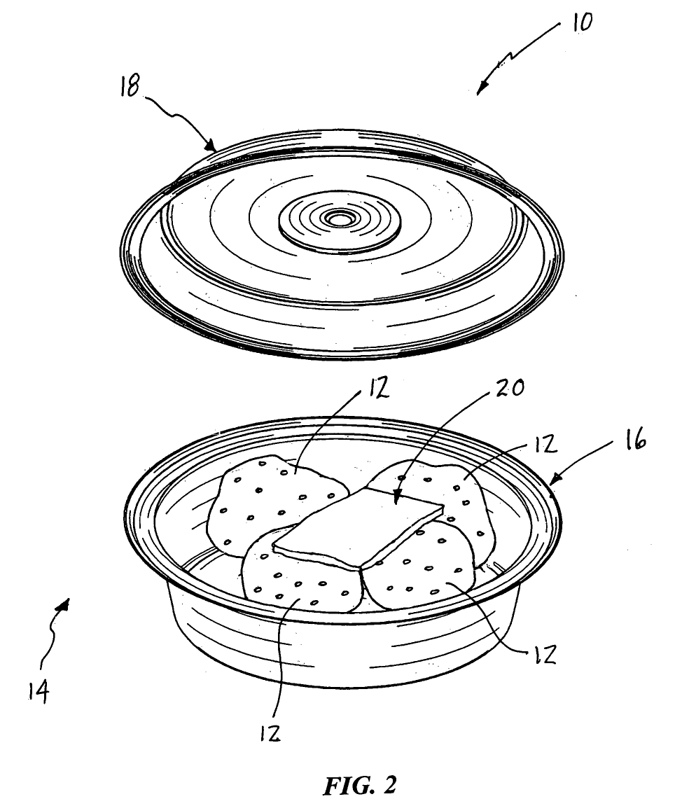

FIG. 2 illustrates the system 10 according to a further embodiment of the present invention, wherein a condiment packet 20 is disposed with the fresh potatoes 12 in the container 14. The condiment packet 20 is provided within the container 14 as added convenience in preparing the fresh potatoes 12 for consumption. To capitalize on this feature, the consumer will preferably remove the condiment packet 20 from the container 14 prior to placement within the cooking environment, and thereafter empty the contents of the condiment packet 20 over the fresh potatoes 12 after they are cooked. The condiment packet 20 may contain any number of suitable condiments, including but not limited to cheese, sour cream, salsa, butter, margarine, and any of a variety of dressings (e.g. Ranch, Thousand Island, etc . . . ). By providing the condiment packet 20 as part of the system 10, the consumer will not be burdened with the added task of buying such condiments separately. Moreover, this also ensures that there will always be a sufficient amount of condiments to apply to the fresh potatoes 12, in that the condiment packet 20 will not be available for consumption prior to using the system 10 of the present invention, thus preventing the “uneven” consumption rates which occur with separately purchased condiments.

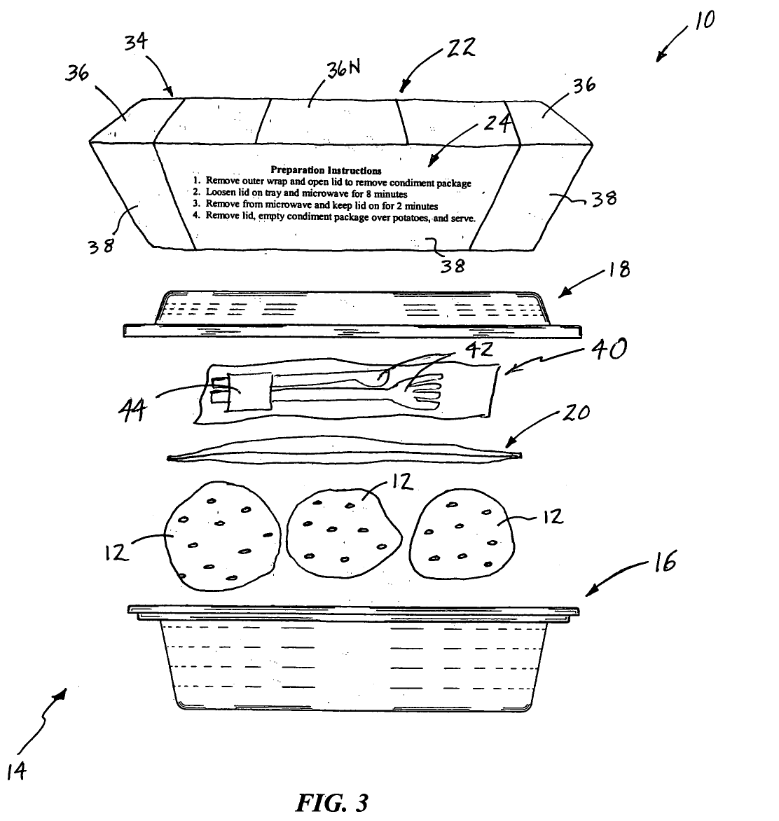

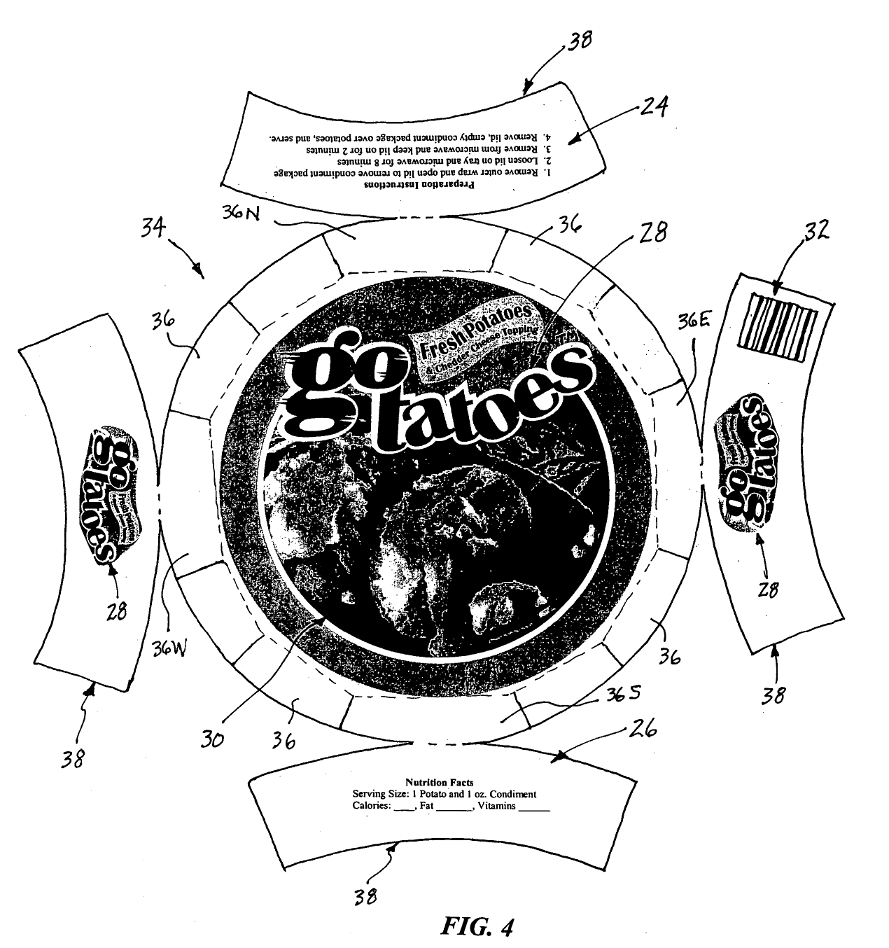

FIG. 3 illustrates the system 10 according to a still further embodiment of the present invention, wherein a packaging cover 22 is provided for placement over the container 14. The packaging cover 22 may be provided with various types of information to communicate, including but not limited to Preparation Instructions 24, Nutrition Facts 26, Brand Name 28, Graphics 30, and Bar Code 32. As will be explained in greater detail below, the packaging cover 22 is constructed (by way of example only) to mimic the general shape of the container 14. To accomplish this, the packaging cover 22 is constructed from a generally planar sheet of material (such as thin cardboard or plastic) and manufactured to include a generally circular center portion 34, a plurality of tab portions 36 hingedly coupled (shown as dashed lines) along the periphery of the center portion 34, and four banner portions 38 hingedly coupled (shown in dashed lines) to tab portions 36N, 36S, 36E, 36W (representing north, south, east and west as viewed in FIG. 4).

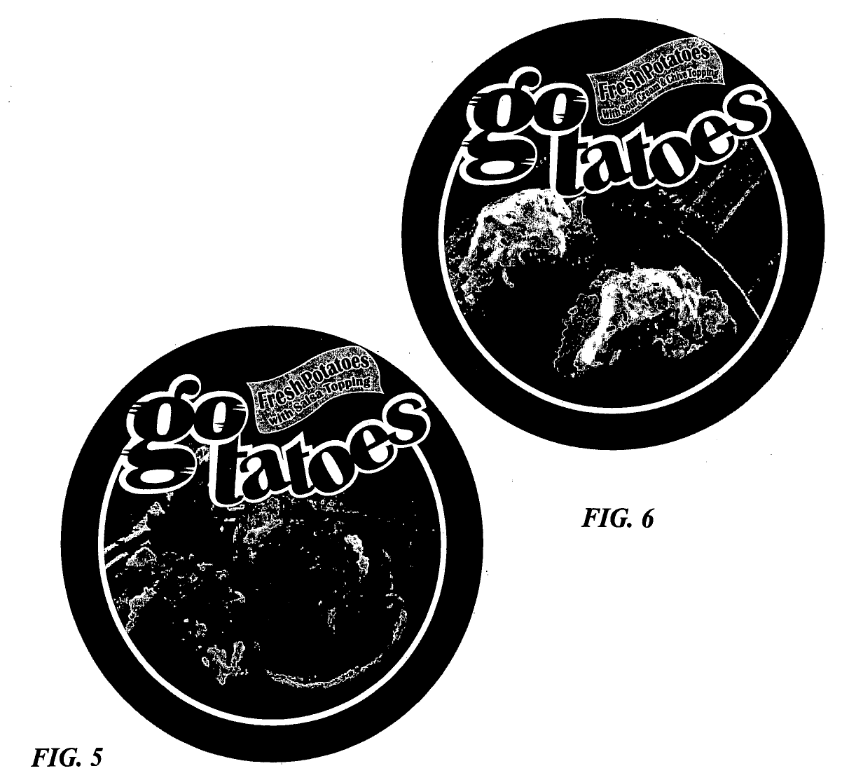

In use, the center portion 34 is positioned over the container 14 (with the fresh potatoes 12 disposed therein with or without the condiment packet 20) and the tab portions 36 are hingedly manipulated such that the tab portions 36 angle downward from the top of the center portion 34 towards the periphery and such that the banner portions 38 angle inward from the periphery to the bottom of the tray 16. In this manner, the banner portions 38 are viewable from the side of the container 14, which is advantageous if the containers 14 are stacked on top of one another or otherwise positioned such that consumers cannot read the Graphics 30 on the top of the center portion 34 (or alternate Graphics 30 shown FIGS. 5 and 6). In this regard, banner portions 38 may include, but are not necessarily limited to, the Preparation Instructions 24, Nutrition Facts 26, Brand Name 28, and Bar Code 32.

Although shown and described above with various information on the packaging cover 22 (to be disposed over the container 14), it is to be readily appreciated that such information may be provided in any number of additional suitable fashions. These may include, but are not necessarily limited to, printing such information directly on or in the container 14 and/or printing such information on an article disposed within the container 14. If printed directly in the container 14 and/or printed on an article disposed within the container 14, then the container 14 must have translucent or “see through” properties to ensure a consumer will be able to read such interiorly disposed information. In addition, the container 14 may be provided with any number of suitable outer coverings or films, including but not limited to foils and/or plastic wrapping for maintaining the container 14 airtight prior to use.

As shown in FIG. 3, the system 10 may also be provided with any number of articles to facilitate consumption of the potatoes 12 without departing from the scope of the present invention. Such articles may be disposed individually within the container 14 or within a plastic wrapper 40, and may include (but are not necessarily limited to) one or more utensils 42 (including knives, forks, and spoons of suitable construction, such as plastic) and/or cleaning articles 44 (including dry napkins and/or “handy-wipes” or napkin-like material with cleaning composition).

As evidenced above, the system 10 of the present invention overcomes the drawbacks with the prior art. The system 10 boasts improved efficiency by reducing the number of steps required to prepare fresh potatoes for consumption, which also advantageously decreases preparation time and makes the process more convenient. The system 10 eliminates the need for separate and distinct cooking receptacles (e.g. pan, foil, plate or pot) by providing the fresh potatoes 12 already in the container 14. This eliminates the time and inconvenience of post-cooking activities, such as washing and storing the pan, plate or pots used to cook the fresh potatoes. The system 10 also overcomes the drawback involving condiments by (in one embodiment) including a condiment packet 20 within the container 14. This eliminates the inconvenience of purchasing condiments separately and, moreover, eliminates the problem of having such “separately purchased” condiments consumed prior to cooking the fresh potatoes, which advantageously ensures a sufficient quantity of condiments will be present when fresh potatoes are cooked according to the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the invention is to cover all modifications, equivalents, and alternative falling within the spirit and scope of the invention as defined by the appended claims.

1. A system for providing fresh potatoes for consumption, comprising:
a container of suitable construction to be placed in and withstand a cooking environment capable of cooking fresh potatoes; and
one or more fresh potatoes placed within said container.

2. The system of claim 1 and further, wherein said container is constructed from microwaveable plastic and includes a tray and a cover.

3. The system of claim 1 and further comprising instructions for cooking said fresh potatoes.

4. The system of claim 3 and further, wherein said instructions include the recommended time for cooking said fresh potatoes within said container within said cooking environment.

5. The system of claim 1 and further comprising a composition for preparing said fresh potatoes for final consumption, said composition disposed within said container.

6. The system of claim 5 and further, wherein said composition comprises at least one of butter, margarine and a dressing.

7. The system of claim 5 and further, wherein said composition is disposed within a package within said container.

8. The system of claim 7 and further, wherein said package is removed from said container prior to cooking.

9. The system of claim 5 and further, wherein said composition is disposed within said container during cooking.

10. The system of claim 1 and further, wherein said one or more fresh potatoes are cleaned prior to being placed within said container.

11. The system of claim 10 and further, wherein said one or more fresh potatoes are cleaned three times prior to being placed within said container.

12. The system of claim 1 and further comprising at least one article for facilitating consumption of said fresh potatoes, said at least one article disposed within said container.

13. The system of claim 12 and further, wherein said at least one article for facilitating consumption of said fresh potatoes comprises at least one of a utensil and a napkin.

14. The system of claim 13 and further, wherein said utensil comprises at least one of a knife, fork, and spoon.

15. The system of claim 13 and further, wherein said napkin comprises at least one of a dry napkin and a napkin treated with a cleaning composition.

16. A method of providing fresh potatoes for consumption, comprising the steps of:
(a) packaging one or more fresh potatoes within a container of suitable construction to be placed in and withstand a cooking environment capable of cooking fresh potatoes; and
(b) distributing said container to a consumer.

17. The method of claim 16 and further, wherein said container is constructed from microwaveable plastic and includes a tray and a cover.

18. The method of claim 16 and further, wherein step (a) includes the sub-step of providing instructions for cooking said fresh potatoes.

19. The method of claim 18 and further, wherein said instructions include the recommended time for cooking said fresh potatoes within said container within said cooking environment.

20. The method of claim 16 and further, wherein step (a) includes the further sub-step of providing a composition for preparing said fresh potatoes for final consumption, wherein said composition is disposed within said container.

21. The method of claim 20 and further, wherein said composition comprises at least one of butter, margarine and a dressing.

22. The method of claim 20 and further, wherein said composition is disposed within a package within said container.

23. The method of claim 22 and further, wherein said package is removed from said container prior to cooking.

24. The method of claim 20 and further, wherein said composition is disposed within said container during cooking.

25. The method of claim 16 and further, wherein step (a) includes the sub-step of cleaning said one or more fresh potatoes prior to being placed within said container.

26. The method of claim 25 and further, wherein said one or more fresh potatoes are cleaned three times prior to being placed within said container.

27. The method of claim 16 and further comprising the step of providing at least one article for facilitating consumption of said fresh potatoes disposed within said container.

28. The system of claim 27 and further, wherein said at least one article for facilitating consumption of said fresh potatoes comprises at least one of a utensil and a napkin.

29. The system of claim 28 and further, wherein said utensil comprises at least one of a knife, fork, and spoon.

30. The system of claim 28 and further, wherein said napkin comprises at least one of a dry napkin and a napkin treated with a cleaning composition.
